(19) United States
(12) Patent Application Publication
(10) Pub. No.: US 2002/0052755 A1
(43) Pub. Date: May 2, 2002

(54) Method and system for providing real estate services using a global network

(76) Inventors: Jerry A. Whatley, Arlington, TX (US); Paul D. Whatley, Glen Rose, TX (US)

Correspondence Address: HOWISON, THOMA & ARNOTT, L.L.P, P.O. BOX 741715, DALLAS, TX, 75374-1715, US

(21) Appl. No.: 09/964,037

(22) Filed: Sep. 26, 2001

Related U.S. Application Data
(60) Provisional application No. 60/235,518, filed on Sep. 26, 2000.

(51) Int. Cl. G06F 17/60

(52) U.S. Cl. 705/1; 705/27; 705/26

(57) ABSTRACT

A method for providing real estate services to the owner of a real property which includes a structure. The method comprises obtaining from the seller, at a time at which a buyer for the property has not yet been identified, a commitment for the purchase of an appraisal covering the property. Thereafter, at a time at which a buyer for the property has not yet been identified, the dimensions of the structure are measured and information sufficient to prepare a floor plan of the structure is collected. Thereafter, at a time at which a buyer for the property has not yet been identified, a web page is coded to display a floor plan of the structure. The web page includes virtual furniture images which are user-positionable. Thereafter, the web page including the floor plan of the structure having user-positionable virtual furniture images is posted on a global network which can be accessed by potential buyers of the property.

### CROSS-REFERENCE TO RELATED APPLICATIONS

This application is related to, and claims the benefits of priority from, U.S. Provisional Patent Application Serial No. 60/235,518, entitled “METHOD AND SYSTEM FOR PROVIDING REAL ESTATE SERVICES USING A GLOBAL NETWORK”, filed Sep. 26, 2000.

### TECHNICAL FIELD OF THE INVENTION

This invention relates generally to methods for providing services using a global computer network. In one aspect, it relates to a method for providing real estate services using a global computer network.

### BACKGROUND OF THE INVENTION

It is estimated that the real estate industry in the United States generates total revenues of approximately $1 trillion annually. Of this total, approximately $125 billion is in the real estate services sector. The service sector's revenues are subdivided as follows: Real Estate Agents—$50 billion; Mortgage Brokers—$25 billion; Miscellaneous Services (e.g., closing services including escrow, courier services, attorney review, document preparation, and filing)—$25 billion; Title Insurance—$13 billion; and Property Site Services (e.g., appraisals, inspections, survey, sign posting, pictures, etc.)—$12 billion.

A significant and ever-increasing portion of real estate transactions involve some use of global computer networks. The Internet is one example of such global networks, however, other public and private networks are known. At the current time, these networks are used primarily for on-line “listing” of properties available for sale. These listings may be prepared and managed by real estate professionals such as Realtors®, e.g., the Multiple Listing Service (“MLS”), or by individuals, e.g., “sale by owner”. In some cases, access to such on-line listings is restricted to real estate professionals. Increasingly, however, on-line listings are being made available to the general public, for example in the form of Internet web pages.

The typical on-line property listing provides one or more web pages with basic data regarding the property, e.g., address, price, square feet, number and type of rooms, lot size, etc. Real estate brokers and agents (hereafter collectively referred to as “agents”) are increasingly seeking to enhance such basic web page listings in order to differentiate their listings from the competition. These web page listing enhancements have two significant benefits. First, they attract more potential buyers to each listing, resulting in faster sales of each property. Second, and possibly more important, they attract more listings to the agent. This is because, generally speaking, sellers of real property utilize a real estate agent based on an expectation that the agent will facilitate selling the property at the quickest possible time. Anything which enhances an agent's ability to sell the property quickly will result more and better listings for the agent, and ultimately, more revenues.

One known method for enhancing web page listings is to provide photographs of the interior and/or exterior of a property on the web page. Buyers are attracted to such web page listings because they can save considerable time compared to actually traveling to the property just to see what it looks like. However, such photographically-enhanced web listings, once considered a novelty, are now offered by many agents. As such, they are less effective in providing a basis for differentiating between real estate agents and thus do not attract new listings as readily. A need therefore exists, for new methods of enhancing real estate listing web sites to attract potential buyers and increase the value of the web site to sellers.

### SUMMARY OF THE INVENTION

The present invention disclosed and claimed herein comprises, in one aspect thereof, a method for providing real estate services to the owner of a real property which includes a structure. The method comprises obtaining from the owner, at a time at which a buyer for the property has not yet been identified, a commitment for the purchase of an appraisal covering the property. Thereafter, at a time at which a buyer for the property has not yet been identified, the dimensions of the structure are measured and information sufficient to prepare a floor plan of the structure is collected. Thereafter, at a time at which a buyer for the property has not yet been identified, a web page is coded to display a floor plan of the structure. The web page includes virtual furniture images which are user-positionable. Thereafter, the web page including the floor plan of the structure having user-positionable virtual furniture images is posted on a global network which can be accessed by potential buyers of the property.

In another embodiment, the invention comprises a method for providing real estate services wherein a service vendor combines an enhanced listing web site service utilizing unique floor plan software with a group of virtual services for the selling owner of real property. The enhanced listing web site with the floor plan software accelerates the selling process for the benefit of the selling owner. The virtual services provided to the selling owner as part of this embodiment include services that would traditionally be purchased by the selling owner at the time of closing, e.g., property site appraisal, title search, title insurance, MLS computer listing, and physical courier services. However, in this embodiment, these services are performed in a unique manner “up-front”, i.e., well prior to the time of closing. The method of this embodiment results in improved efficiency for providing the enhanced web site services and the virtual services. It also cuts 1 to 3 weeks from the elapsed time required to fund the house loan such that the closing can occur sooner.

The services of the embodiment are sold by the service vendor (hereinafter referred to as “CNB”) to the selling owner and paid by him only if his property is sold. However, it is contemplated that the real estate agent will typically initiate and/or facilitate the sales contact between CNB and the selling owner. In order to induce the agent to participate in the program (i.e., by initiating and/or facilitating the sales contract), CNB constructs a unique computer MLS listing of the agent's house. Further, CNB may conduct the closing event in the agent's office, for which the agent may receive an fee.

In this embodiment, the property buyer pays his normal closing costs including organization fee, appraisal fee, survey, deed recordings, credit report, courier, and closing fee. The selling owner purchases the appraisal and title search on initial sign-up with CNB, however the fees are typically deferred until closing. The title policy is purchased at closing. All 3 of these items—appraisal, search, and policy—are purchased by the selling owner and paid at closing. The title policy is issued by American Land or some other AAA rated company and resold by CNB.

It is contemplated that the unique web listing with floor plan, posted when the property is listed for sale, will obtain more listings for the agent and sell the property more quickly for the agent and seller. By combining this enhanced listing service with the up-front timing of the appraisal and title search, 1 to 3 weeks are cut from the elapsed time required to fund the house loan. In addition, since common information is required for both the appraisal and floor plan for the enhanced web listing, the up-front timing of the appraisal commitment results in an unexpected benefit, i.e., reducing the cost of providing the services to the selling owner.

### BRIEF DESCRIPTION OF THE DRAWINGS

For a more complete understanding of the present invention and the advantages thereof reference is now made to the following description taken in conjunction with the accompanying drawings in which:

FIGS. 1-2 illustrate a flowchart for a method for providing real estate services in accordance with one embodiment of the invention;

FIG. 3 illustrates a LOGIN screen for a web site in accordance with another embodiment of the invention;

FIG. 4 illustrates a web page header for the web site including tab-shaped hyperlinks providing links to related web pages;

FIG. 5 illustrates a web page associated with the “FLOOR PLAN & FURNISH IT” hyperlink tab of FIG. 4;

FIG. 6 illustrates a web page having an enlarged view of the floor plan for a selected room of FIG. 5 in an unfurnished mode;

FIG. 7 illustrates a web page having an enlarged view of the floor plan for a selected room of FIG. 5 in a user-furnishable mode;

FIG. 8 illustrates a detail view of the web page of FIG. 7 showing the resizing of a furniture image;

FIG. 9 illustrates a web page associated with the “PHOTOGRAPHS” hyperlink tab of FIG. 4;

FIG. 10 illustrates a web page associated with the “HOME DETAILS” hyperlink tab of FIG. 4;

FIG. 11 illustrates a web page associated with the “LOT PLAN” hyperlink tab of FIG. 4; and

FIG. 12 illustrates a diagrammatic view of a system for advertising real estate property on a global network in accordance with another embodiment.

### DETAILED DESCRIPTION OF THE INVENTION

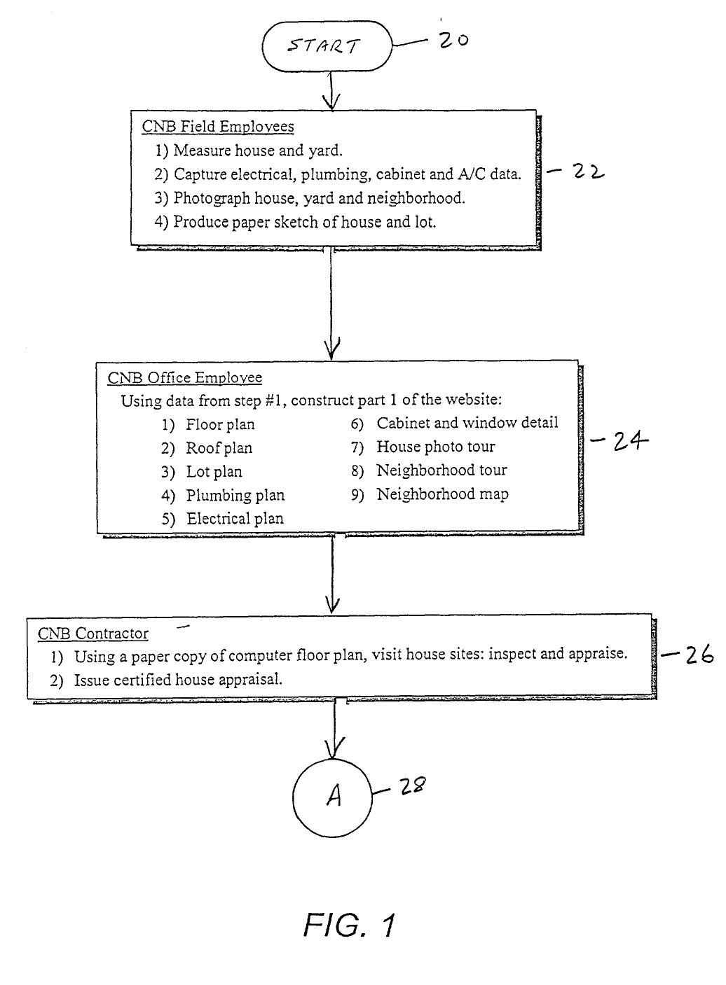

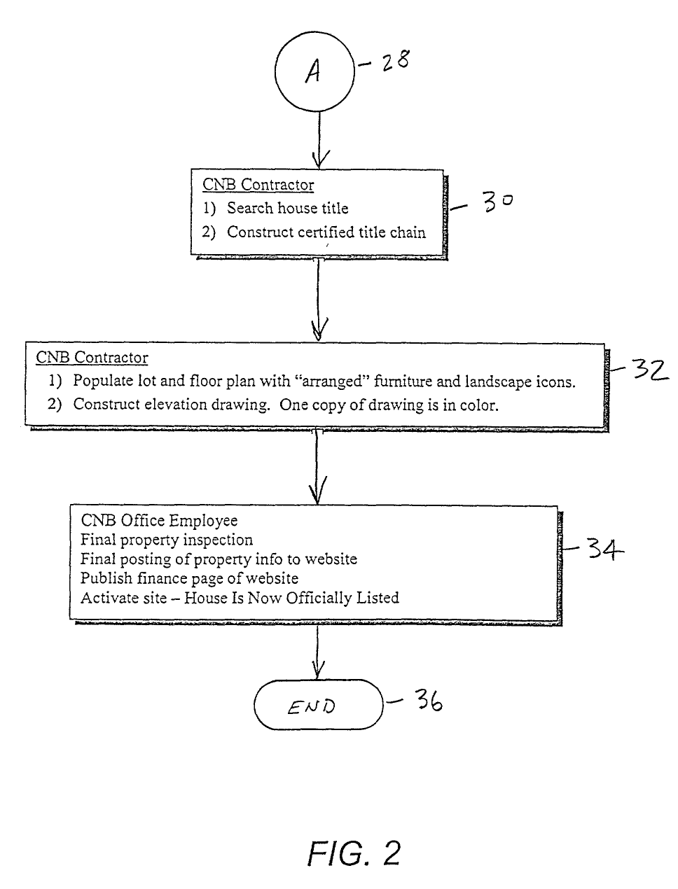

Referring now to FIGS. 1 and 2, there is illustrated a flowchart of the method in accordance with one embodiment, referred to hereafter as the “CNB web system.” The CNB web system consists of a series of services performed on a “for sale” house. The services are intended to expedite the sale and the mortgage of the house. The services consist of a bundle of on-site (the house site) services coupled with off-site computer services:

A) The on-site services consist of: data gathering, photograph gathering, sign posting, lock box placement, and certified appraisal.

B) The off-site computer services consists of: a title search, construction of a unique web site for the house, and maintenance of the house web site.

In this embodiment, these services are completed within the first 14 days of a property entering the “for sale” category. The timing of the services, i.e., before a buyer is found, is of the utmost importance in delivering a salability enhancement of the property. As a result of this timing, when the house first appears on MLS it can appear with a floor plan, designer placement of furnishing icons and landscape icons, a pictorial tour of the neighborhood and of the house and many other salability enhancement features. In addition to the salability enhancements provided by the CNB computer work, the timing of the work is also important. Because the work is performed early in the selling process, the time required by a buyer to obtain a mortgage is shortened. The house sells more quickly, for more money, and is funded more quickly. Total time saving is estimated to be from 4 to 8 weeks.

Referring still to FIGS. 1 and 2, the following is a description, in chronological order, of the activities comprising the CNB Web Real Estate System. The method starts at function block 20 (FIG. 1), wherein it is understood that a property owner desiring to sell a property (hereafter “selling owner”) has been identified. In some embodiments, a commitment for purchase of services, e.g., a property appraisal, title search, or title policy, has been obtained from the selling owner. The process then moves to function block 22, wherein CNB field employees perform the following actions: 1) measure house and yard; 2) capture electrical, plumbing, cabinet and A/C data; 3) photograph house, yard and neighborhood; and 4) produce paper sketch of house and lot. The process then moves to function block 24, wherein CNB Office Employee, using data obtained from the actions in block 22, constructs the first part of the web site, including: 1) floor plan; 2) roof plan; 3) lot plan; 4) plumbing plan; 5) electrical plan; 6) cabinet and window detail; 7) house photo tour; 8) neighborhood tour; and 9) neighborhood map. The process then moves to function block 26, wherein a CNB contractor, using a paper copy of the computer floor plan, visits the house site to inspect and appraise. The CNB contractor further issues a certified house appraisal. Following the steps in block 26, the process continues through connector block 28 to function block 30 (FIG. 2).

In function block 30, the CNB contractor performs the following actions: 1) search house title; and 2) construct a certified title chain. The process then moves to function block 32, wherein the CNB contractor performs the following actions: 1) populates the lot and floor plan with “arranged” furniture and landscape icons; and 2) constructs elevation drawings. Preferably, one copy of the drawings is in color. Next, the process then moves to function block 34, wherein the CNB office employee performs the following actions: 1) final property inspection; 2) final posting of property information; 3) Publishing finance page of web site; and 4) activating listing web site for the property. At this point, the property is now officially “listed”. This represents the end of this embodiment, as indicated by “END” block 36.

Another aspect of the current invention is the CNB software system. The CNB software system is used to aid CNB in the delivery of a bundle of house (i.e., site and/or property) specific services. The bundle will expedite the sale and mortgage of the house. The CNB client is intended to be the real estate agent, or FSBO agent, in partnership with the selling owner. These people are, together, the CNB client. In one embodiment, the charge for the service is zero if the house remains unsold for a period of 6-12 months. Specifically, Q2 & Q3 listings are to be sold within 6 months or zero payment and Q4 & Q1 listings are to be sold within 12 months or zero payment. In this embodiment, the CNB charge varies from $600 to $1,400 per house (depending on house size). Charges are expected to average $800 per house.

The CNB service bundle consists of the following 11 services:

1) Measuring and drawing the floor plan

2) Preparing a certified EDI inspection

3) Preparing a certified EDI appraisal

4) Preparing a certified EDI survey

5) Photograph and post 24 photos of house: outside, inside, yard, and neighbor views.

6) Prepare current lot and landscape diagram plus recommended diagrams.

7) Prepare recommended furniture placement and recommended planting placement.

8) Prepare neighborhood map of significant features. Prepare and post neighborhood and village statistics plus financing sheet.

9) Prepare and post photos and data to MLS plus realtor site.

10) Prepare and post house items to CNB server site.

11) Plant “For Sale” sign

In one embodiment, the CNB software system will have the following specifications:

Users and Storage—The software should anticipate an average 300,000 users per day and a file of 1.5 million houses. This 1.5 million includes saved furniture variations. Each house file should carry along up to 100 unique user ID's.

User Configuration and Furniture Placement—The CNB software system will open on an unfurnished floor plan of the first, or main, floor. The software will provide for up to 6 stories (levels) for a house with up to 12 rooms per level. Outbuildings will be treated as a separate level and will have a floor plan. (An outbuilding is any building on the lot to be sold but detached from the house. This includes a detached garage).

The floor plan for each level will be broken into individual rooms. Clicking on an individual room opens that room up in designated modification area (room plan). The viewer will make modifications and have the option of saving these modifications. Any saved modifications in a room plan are used to update the overall floor plan.

Furniture Selection & Storage—Each room in a floor plan will have the capacity to contain up to 50 furniture items. (This 50 includes lamps, pictures and rugs). The average room will contain about 20 items. Each piece will be shown on a pull-down room inventory menu. The menu will show the size of the piece and an estimated price for replacements. The dimensions, or price, may be changed by the viewer. The pull-down menu may contain several hundred items for a particular room.

Hard Drive Storage & Usage—The initial furniture (and landscape) placement and inventory will be constructed by the posting person. For each room plan, the furniture inventory, with prices and quantifiers, may be printed as a separate report.

The lot plan can also be divided into and up to 12 sections. The lot plan is treated like a house level by the CNB software system.

To summarize, the database for a house: max. levels is 6, max. room per level is 12, max. pieces per room is 50. The lot is simply treated like another house level. The basic database has 6×12×50=3,600 items each with up to 10 characteristics. This, the basic unit database, has 36,000 maximum elements times three.

The CNB service bundle was previously described. The CNB house bundle refers to those groups of pages making up the CNB software system. Each page in each group presents the viewer with an image that conveys information concerning the house. Referring now the FIGS. 3-11, elements of the house bundle are described.

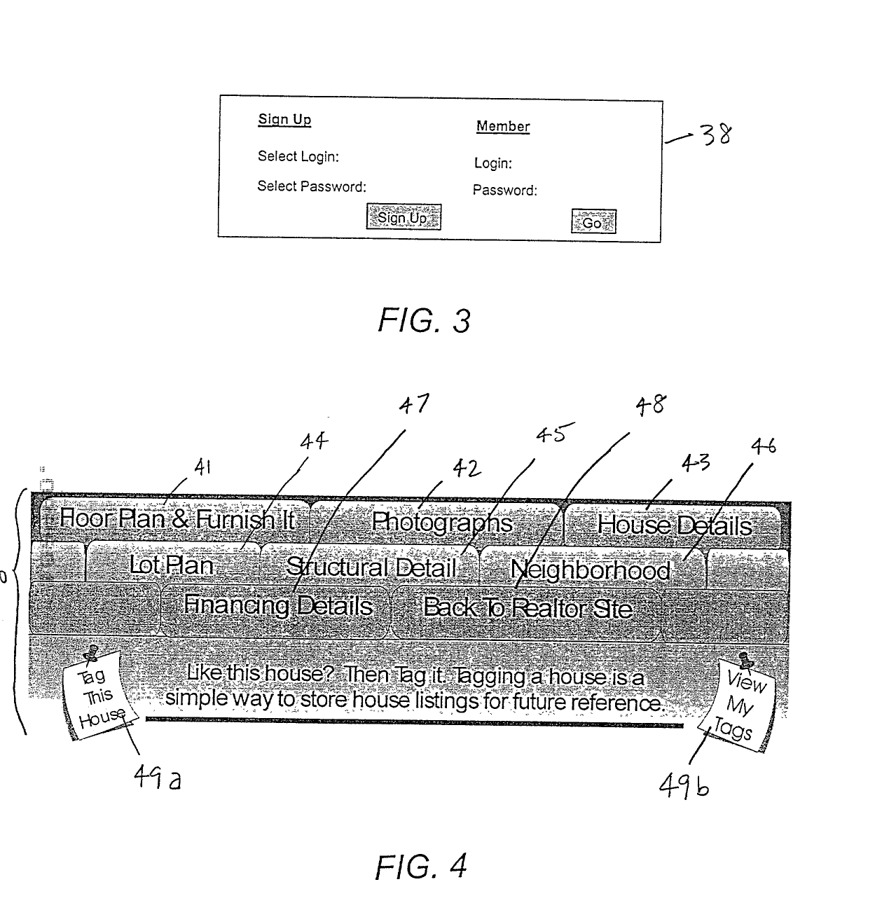

Referring specifically to FIG. 3, there is illustrated the LOGIN screen window 38 which appears on the listing web site when the user activates the site for the first time. This LOGIN window 38 should be simple without having to take personal information. This window should pop up whenever a viewer clicks one of the auxiliary “sticky note” hyperlinks (e.g., “Tag This House” or “View My Tags”) (see FIG. 4) for the first time during any given session.

Referring now to FIG. 4, there is illustrated a page header 40 appearing at the top of every page of the listing web site. The page header 40 includes eight hyperlinks 41 through 48. In the embodiment shown, these hyperlinks are shaped like file folder tabs and called Tab 1 (denoted by reference number 41), Tab 2 (denoted by reference number 42), Tab 3 (denoted by reference number 43), Tab 4 (denoted by reference number 44), Tab 5 (denoted by reference number 45), Tab 6 (denoted by reference number 46), Tab 7 (denoted by reference number 47), and Tab 8 (denoted by reference number 48). It will be apparent, however, that other appearances and names could be substituted. Selecting (i.e., clicking) a hyperlink (i.e., Tab) causes a related group of web pages to be displayed as further described below. The active Tab, i.e., the hyperlink of which pages are currently being viewed, is highlighted in a way to remind the viewer which page they are on.

Just below the standard tabs 41-48 are two more hyperlinks having the appearance of virtual “sticky notes”. In the embodiment shown, these hyperlinks are named “Tag This House” (denoted by reference number 49a) and “View My Tags” (denoted by reference number 49b). Clicking hyperlink 49a or 49b for the first time brings up the login window 38.

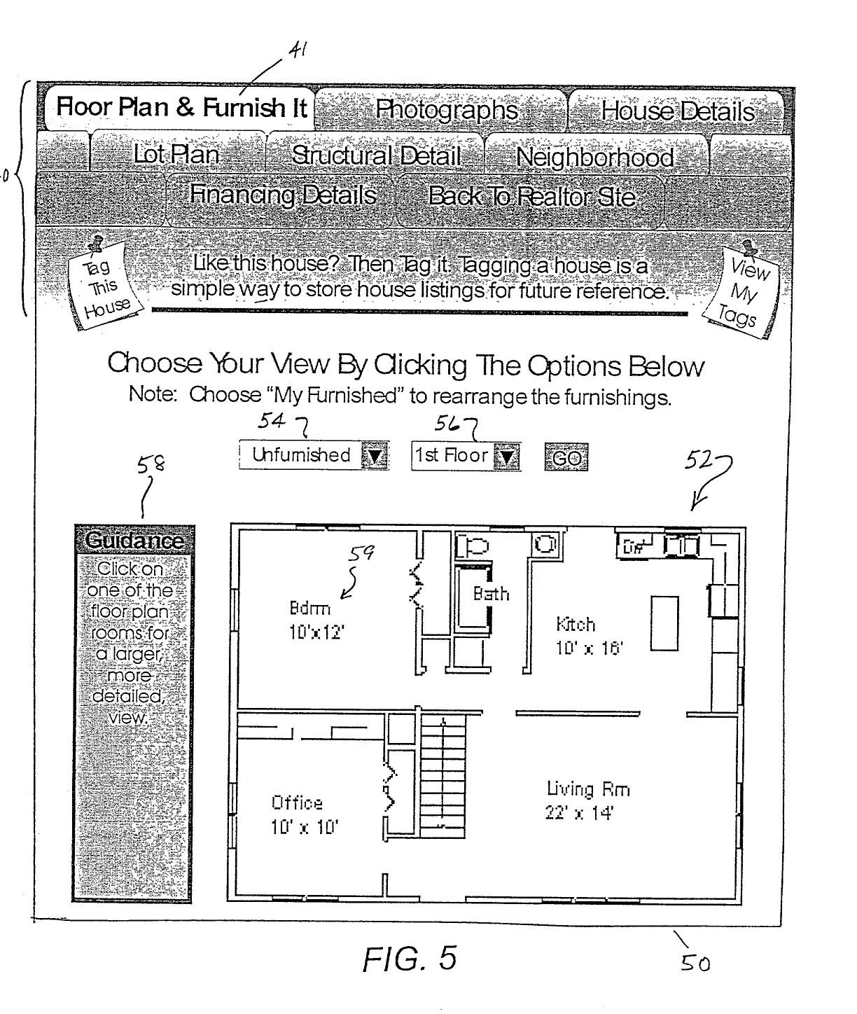

Referring now to FIG. 5, there is illustrated a web page 50 displayed when hyperlink Tab 1 (reference number 41) is clicked, i.e., the pages for “Floor Plan & Furnish It”. The first page of this group includes an unfurnished level floor plan 52 of the main level of the house (or other structure on the property). A viewer sees this page as an entry page to the CNB server site. This group has a floor plan for each of the up to 6 levels of the house. (The lot is treated as a level but has a page (tab) of it's own). Each level has an unfurnished plan, a furnished plan, and may have a viewer-furnished placement plan. Thus each house could have an initial 3×36,000 element on the hard drive.

Users of the “Floor Plan & Furnish It” web page 50 can select from a number of floor plan display options using a first drop-down menu 54 (having options entitled “Unfurnished”, “Furnished”, and “My Furnished”) and a second drop-down menu 56 (having options entitled “1^{st} Floor”, 2^{nd} Floor”, “Basement”, “Attic”, etc (which ever applies to the current house)). A “Guidance Box” 58 presents text which changes depending on the view the user is viewing.

The level floor plan 52 actually comprises additional hyperlinks representing each individual room of the level. Clicking on room hyperlink (e.g., the “BDRM” link denoted by reference number 59) opens a new window with enlarged picture of the subject room that was clicked on.

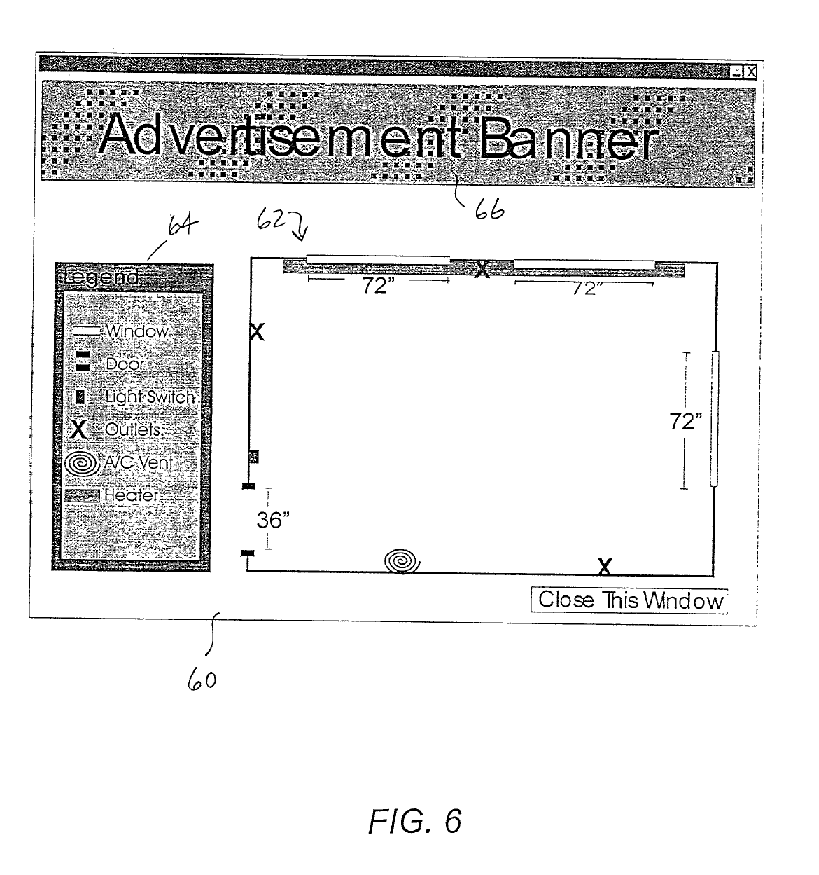

Referring now to FIG. 6, there is illustrated a web page 60 showing an unfurnished room floor plan 62 of the type displayed upon clicking a room hyperlink 59 when the first drop-down menu 54 was set to “Unfurnished”. In this case, the room floor plan 62 shows electrical detail and legend. The web page 60 may also include a legend 64 and/or an advertising banner 66.

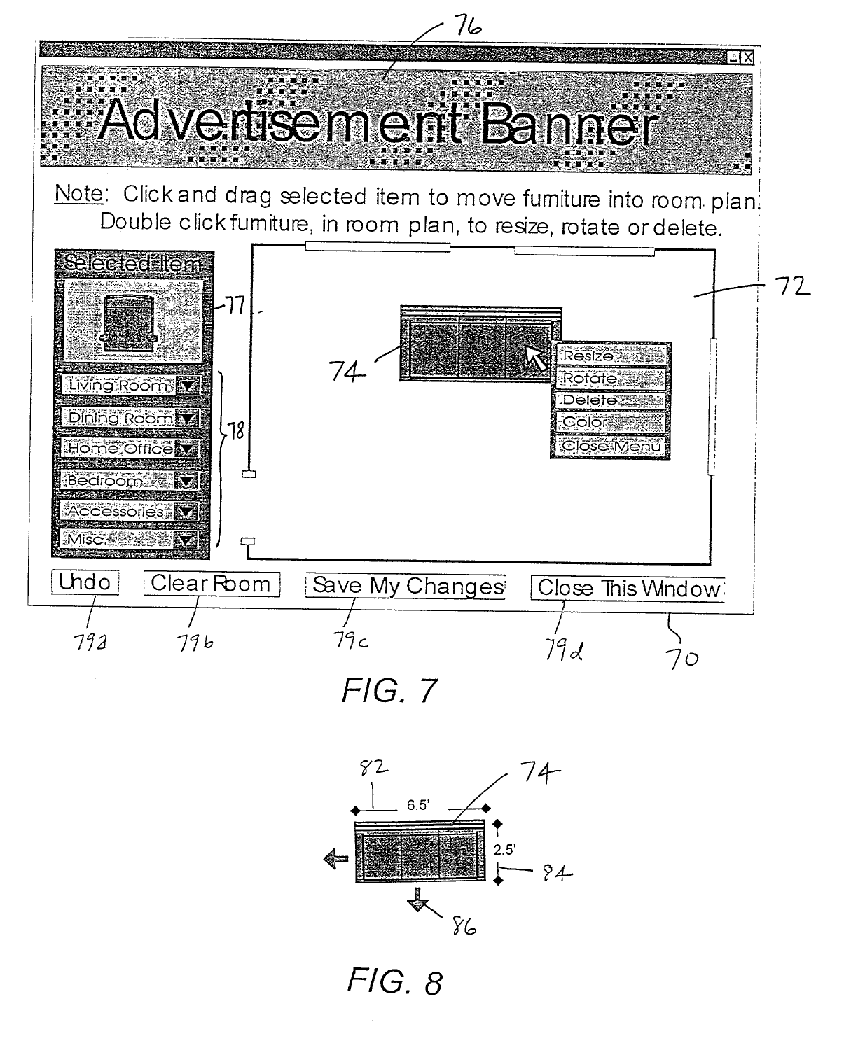

Referring now to FIG. 7, there is illustrated a web page 70 showing a furnished room floor plan 72 of the type displayed upon clicking a room hyperlink 59 when the first drop-down menu 54 was set to “Furnished”. In this case, the room floor plan 72 depicts furniture icons 74 in a standard furniture arrangement. The web page 70 may also include an advertising banner 76. If, however, the room hyperlink 59 was clicked when the first drop-down menu 54 was set to “My Furnished”, then the web page 70 shows the same room floor plan 72 as the “Furnished” room but the furniture (i.e., the furniture icons 74) is now clickable. This window 70 has a “Selected Items” box 77 displaying a plurality of drop-down menus 78 for furniture options and a number of window “radio buttons” 79a-79d, e.g., “Undo” (reference 79a), “ClearRoom” (reference 79b), “Save My Changes” (reference 79c), and “Close This Window” (reference 79d). If a viewer clicks the “Save My Changes” button 79c, then when the window 70 is closed, the original larger floor plan window 52 is updated with these room changes.

The clickable furniture icons 74 of the “My Furnished” floor plan 72 function as follows. The user first selects the type of furniture icon desired from drop-down menus 78. Next, the user “clicks and drags” the furniture in “Selected Item” box 77 onto the room plan 72.

Referring now to FIG. 8, there is illustrated the editing of a clickable furniture icon 74. First, the user double clicks (or right clicks, depending on the embodiment) the furniture icon 74 (already located in room plan) for a side menu (not shown) that contains the options of. 1) resize; 2) rotate; 3) delete; 4) color; and 5) close menu. After clicking the “Resize” option, the side menu disappears and the furniture item 74 is shown adjacent a length dimension bar 82 and a width dimension bar 84 with measurements. Clicking and dragging directional arrows 86 resizes the icon 74 as the dimension bars 82, 84 show the new sizes. Upon clicking the “Rotate” option from the side menu, the menu doesn't disappear but the item selected rotates a fixed amount, e.g., 45°. The menu stays open so the buyer can click rotate as many times as they wish until the furniture is at the angle they wish. Upon clicking the “Delete” option, the side menu disappears as well as the furniture that was clicked. Upon clicking the “Color” option, the side menu does not disappear. Instead, a 10-color palette appears. Once a color is clicked, then the side menu disappears, the color palette disappears, and the selected furniture icon 74 changes to the selected color.

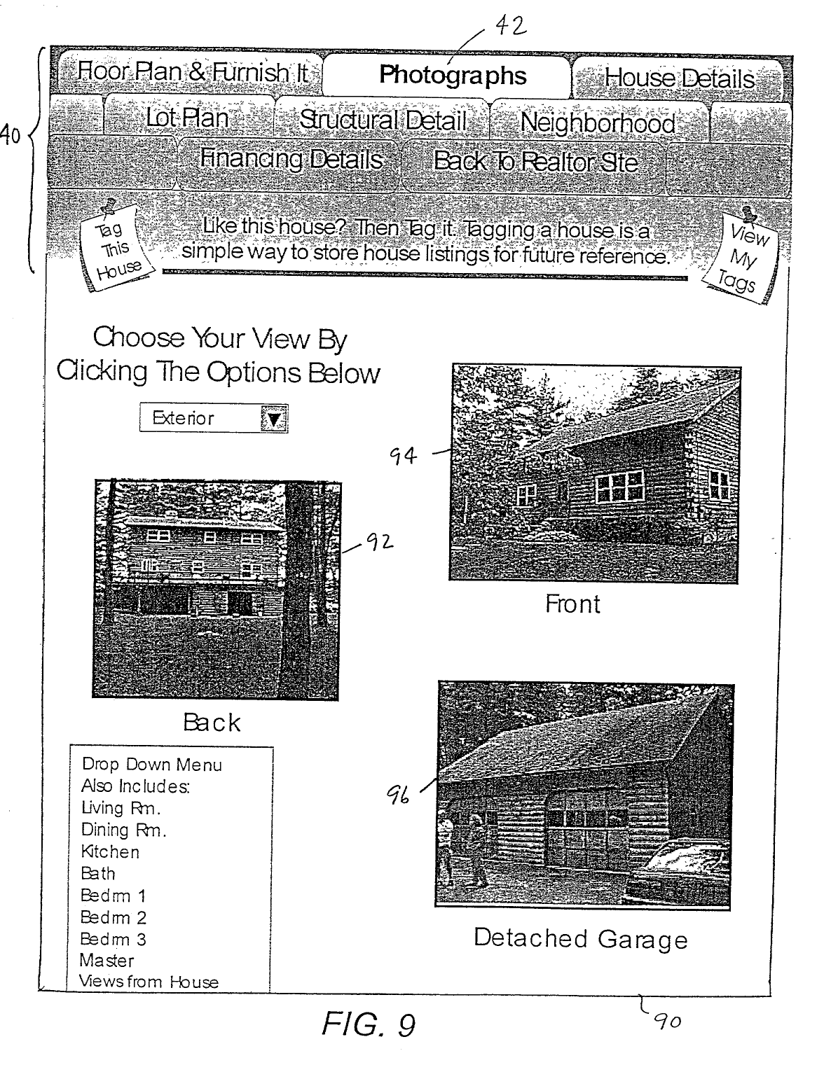

Referring now to FIG. 9, there is illustrated a web page 90 displayed when hyperlink Tab 2 (reference number 42) is clicked, i.e., the pages for “Photographs”. The first page of this group opens to a series of photos 92, 94, 96 of the outside elevation of the house. There are a number of such photo pages for the exterior, interior (includes individual pages for each room), yard, grounds, and neighborhood. (All photo's give date taken).

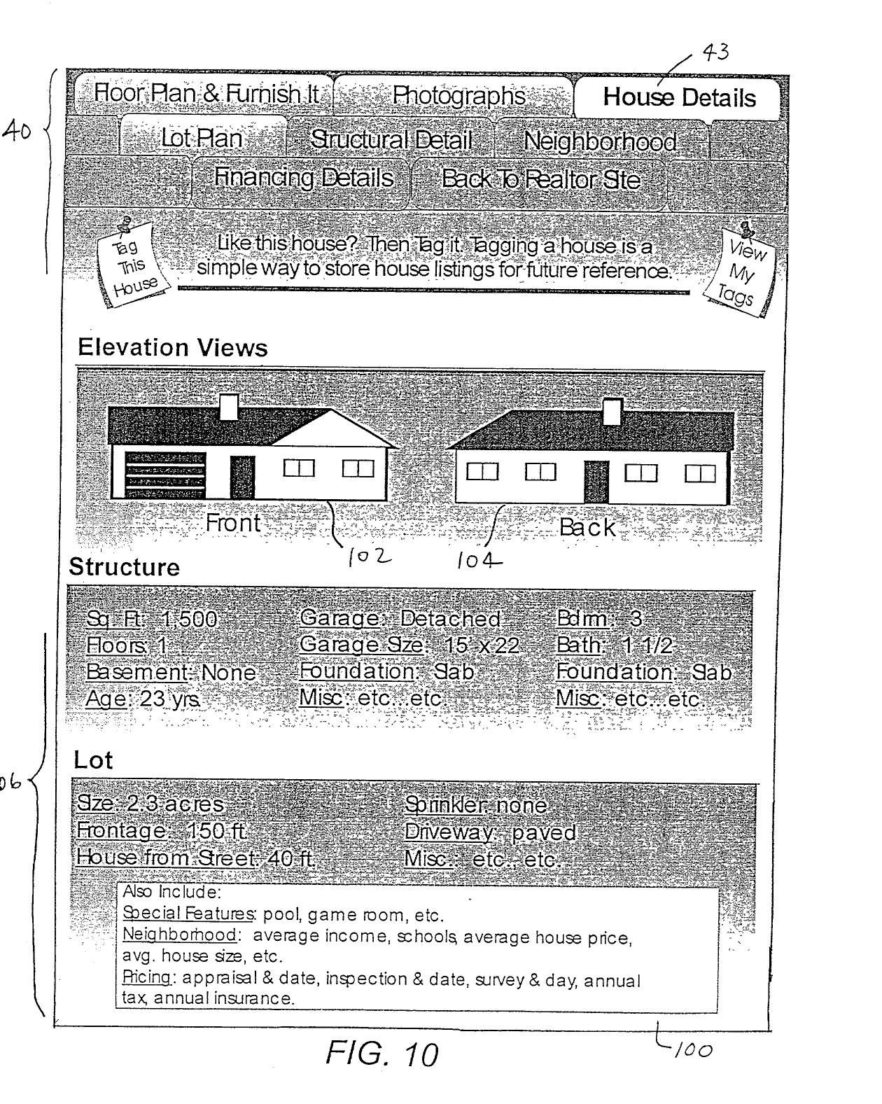

Referring now to FIG. 10, there illustrated a web page 100 displayed when hyperlink Tab 3 (reference number 43) is clicked, i.e., “House Details”. The first page of this group shows a front elevation drawing 102 and a back elevation drawing 104 of the house and gives a summary 106 of the details of a house that might interest the buyer. The viewer can click to a number of colors and trim elements from House Details in order to view variations in the house appearance.

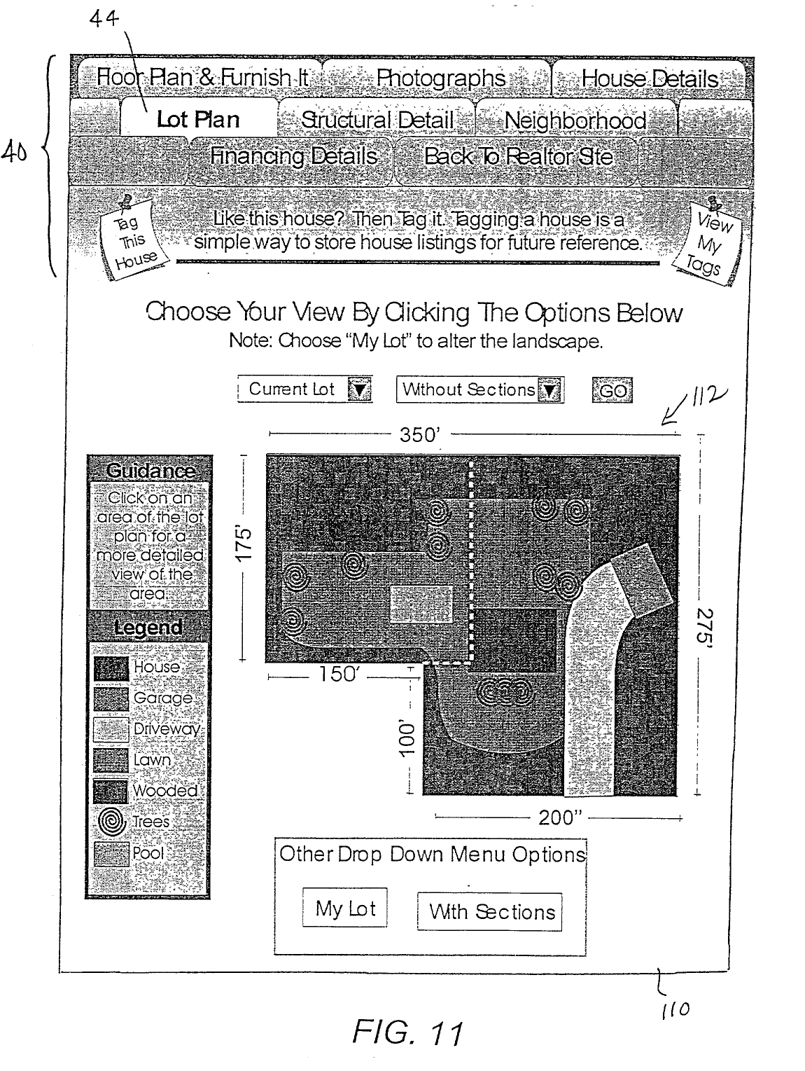

Referring now to FIG. 11, there is illustrated a web page 110 displayed when hyperlink Tab 4 (reference number 44) is clicked, i.e., “Lot Plan”. The first page of this group shows a plan view 112 of the existing lot with existing plant placement. The second page shows a recommended plant placement. Each user may have a separate, personalized, lot plan. A note (not shown) on this page may be used to inform the user that a sprinkler plan may be found on Tab 5 (Structural Detail).

Other groups (not shown) of web pages may be accessed by clicking on additional hyperlinks in the page header 40 as described below.

When hyperlink Tab 5 (reference number 45) is clicked, i.e., “Structural Detail”, information is presented regarding: 1) Foundations & Grounds Plan—This shows plumbing, gas, sewer, water, sprinkler, storm drain, underground utilities, etc.; 2) Roof Plan & Gutter Plan; 3) Electric Plan—This plan shows outlets and light switches; 4) Heating & Air Conditioning Plan—This plan shows vents and radiator locations; 5) Plumbing Plan—This plan shows all water and drain types and locations; 6) Cabinet Detail Plan; and 7) Door & Window Schedule—This plan shows all door and widows with dimensions and types.

When hyperlink Tab 6 (reference number 46) is clicked, i.e., “Neighborhood”, information regarding the property's neighborhood is presented. The first page is a CNB composed map showing the house in relation to fire, police, hospital, shopping, schools, bus and train stops. Clicking on each of these items produces a more elaborate description of each. Also included is very detailed information with phone numbers and web sites of the village, MSA, and state government.

When hyperlink Tab 7 (reference number 47) is clicked, i.e., “Financing Details”, information regarding possible financing of the the property is presented. This page shows: projected closing cost details, credit rating practice, mortgage rates, income comparisons, etc. Presentations is in graphic form: appraisals, surveys, inspections.

When hyperlink Tab 8 (reference number 48) is clicked, i.e., “Back To Realtor Site”, this closes our web site's window.

Clicking auxiliary hyperlink 49b, i.e., “View My Tags”, takes the viewer to a page that lists each house ever tagged. The list is clickable and includes the following information: house address, asking price, MLS#, and realtor name & number. Once a listing is clicked, the “Floor Plan & Furnish It” (i.e., hyperlink 41) page for that house opens up.

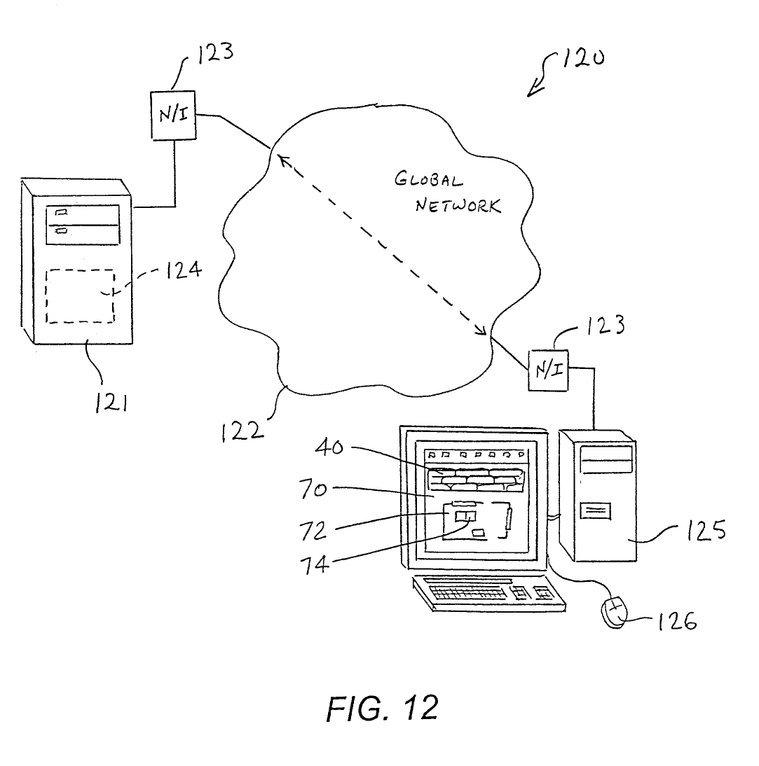

Referring now to FIG. 12, there is illustrated a system for listing (i.e., advertising) real estate property on a global network. The real estate property to be advertised will typically include a house, building, or other structure having a plurality of rooms disposed in a physical arrangement known as a floor plan. The system 120 includes a first computer 121 disposed at a first location on the global network 122. The first computer 121 will typically be a server under the direct or indirect control of the service provider, i.e., the advertiser. The global network 122 will typically be the Internet, however, it will be apparent that the system may also be constructed using other public or private computer networks. The first computer 121 is operably connected to the global network 122 through a network interface 123. Software code 124 is disposed on the first computer 121. The software code 124 operates to produce one or more web pages which display a floor plan for the house (or building or other structure, as applicable) on the property to be advertised. The software code 124 also allows virtual furniture images to be positioned by the user on the displayed web page. In one embodiment, the software code 124 is the CNB software system previously described and illustrated herein (FIGS. 3-11).

The system 120 further includes a second computer 125 disposed at a remote location on the global network 122. The second computer 125 will typically be a PC-type computer located in the home of potential buyers of the property. The second computer 125 is connected to the global network 122 by a network interface 123 (e.g., a telephone modem, cable modem, etc.) through an ISP (not shown). Using known Internet protocols (e.g., TCP/IP) the second computer is adapted to retrieve (i.e., download) the software code 124 across the global network 122 from the first computer 121. Upon executing the software code 124, the second computer 125 can then display the web pages, e.g., web page 70 (FIG. 7), including the floor plan, e.g., floor plan 72 (FIG. 7), which depicts the physical arrangement of rooms in the house or other structure of the advertised property. Further, the user of the second computer 125 can use the software code 124 to reposition and/or resize the virtual furniture images 74 (FIGS. 7-8) on the displayed web page using a mouse 126 or other computer pointing device. In another embodiment, the software code is further adapted to allow the user of the second computer 125 to store the customized (i.e., personalized) positions of the virtual furniture on the displayed web page for later retrieval.

Although the preferred embodiment has been described in detail, it should be understood that various changes, substitutions and alterations can be made therein without departing from the spirit and scope of the invention as defined by the appended claims.

What is claimed is:

1. A method for providing real estate services to the owner of a real property which includes a structure, the method comprising the steps of:
obtaining from the owner, at a time at which a buyer for the property has not yet been identified, a commitment for the purchase of an appraisal covering the property;
thereafter measuring, at a time at which a buyer for the property has not yet been identified, the dimensions of the structure and collecting information sufficient to prepare a floor plan of the structure;
thereafter coding, at a time at which a buyer for the property has not yet been identified, a web page to display a floor plan of the structure, the web page including virtual furniture images which are user-positionable; and
thereafter posting on a global network which can be accessed by potential buyers of the property, the web page including the floor plan of the structure having user-positionable virtual furniture images.

2. A method in accordance with claim 1, further comprising the step of obtaining from the owner, at a time at which a buyer for the property has not yet been identified, a commitment for the purchase of a title search covering the property.

3. A method in accordance with claim 2, further comprising the step of obtaining from the owner, at a time at which a buyer for the property has not yet been identified, a commitment for the purchase of a title insurance policy covering the property.

4. A system for advertising real estate property on a global network, the real estate property including a structure having a plurality of rooms disposed in a physical arrangement, the system comprising:
a first computer disposed at a first location on the global network;
software code disposed on the first computer, the software code operating to display a web page including a floor plan which depicts the physical arrangement of the plurality of rooms of the structure and which allows virtual furniture images to be positioned on the displayed web page;
a second computer disposed at a remote location on the global network, the second computer being adapted to retrieve the software code across the global network from the first computer;
whereby the second computer can display the web page including the floor plan which depicts the physical arrangement of the plurality of rooms of the structure and the user of the second computer can reposition the virtual furniture images on the displayed web page.

5. A system in accordance with claim 4, wherein the global network is the Internet.

6. A system in accordance with claim 4, wherein the software code is further adapted to allow the user of the second computer to store the positions of the virtual furniture on the displayed web page for later retrieval.
